(19) United States
(12) Patent Application Publication
(10) Pub. No.: US 2017/0136651 A1
(43) Pub. Date: May 18, 2017

(54) PORTABLE ELECTRICAL CUTTING APPLIANCE WITH A HEATED WIRE

(71) Applicant: PROCARV, Voiron (FR)

(72) Inventor: David ANNEQUIN, Colombe (FR)

(21) Appl. No.: 15/308,811

(22) PCT Filed: May 13, 2015
(86) PCT No.: PCT/FR2015/051253

§ 371 Date: Nov. 3, 2016

(30) Foreign Application Priority Data
May 14, 2014 (FR) 1401084

(51) Int. Cl. B26F 3/12; B26B 29/06; B26B 27/00

(52) U.S. Cl. CPC B26F 3/12; B26B 27/002; B26B 29/06

(57) ABSTRACT

The portable electrical portable appliance is hand portable and it operates on a rechargeable battery in order to cut polystyrene with a hot wire in accurate manner with the help of a cutting guide system that is linear and that can be swiveled. The appliance is particularly for installing housing insulation.

### TECHNICAL FIELD OF THE INVENTION

The invention relates to a portable electrical appliance for cutting materials such as expanded or extruded polystyrene.

### STATE OF THE ART

In the field of housing construction, where polystyrene is omnipresent for outdoor insulation, indoor insulation, floor insulation, roof insulation, such polystyrene elements are cut using wood saws. The work is tedious, lengthy, and not necessarily straight. Such polystyrene elements can be cut using machines that operate at 220 volts (V), but that type of power supply is not always available. Such machines are bulky and heavy to use on scaffolding or on a roof.

### OBJECT OF THE INVENTION

It is found that there exists a need to provide a cutter appliance that enables those drawbacks to be remedied.

This need tends to be met by means of a cutter appliance in accordance with the accompanying claims, and more particularly by means of a cutter appliance that comprises:
a grip body;
a cutter wire tensioned between a bracket and the grip body;
a rechargeable battery for powering and heating the cutter wire under the control of a pushbutton;
a guiding angle bar configured to swivel in a vertical plane and in a horizontal plane; and
a linear rail screwed onto the grip body and co-operating with a ball bearing in order to enable the guide angle bar to slide so as to cut accurately straight.

In a particular embodiment, a graduated protractor sets the pivot angle of the guide angle bar on the vertical plane from 0° to 45° and locks it by means of a button.

In a variant embodiment, a graduated protractor sets the pivot angle of the guide angle bar on the horizontal plane from 0° to 45° and locks it using the wing nut.

### BRIEF DESCRIPTION OF THE DRAWINGS

Other advantages and characteristics appear more clearly from the following description of particular embodiments of the invention given as non-limiting examples and shown in the accompanying drawings, in which:

FIG. 1 is a diagrammatic overall view of a cutter appliance seen looking in a first direction;

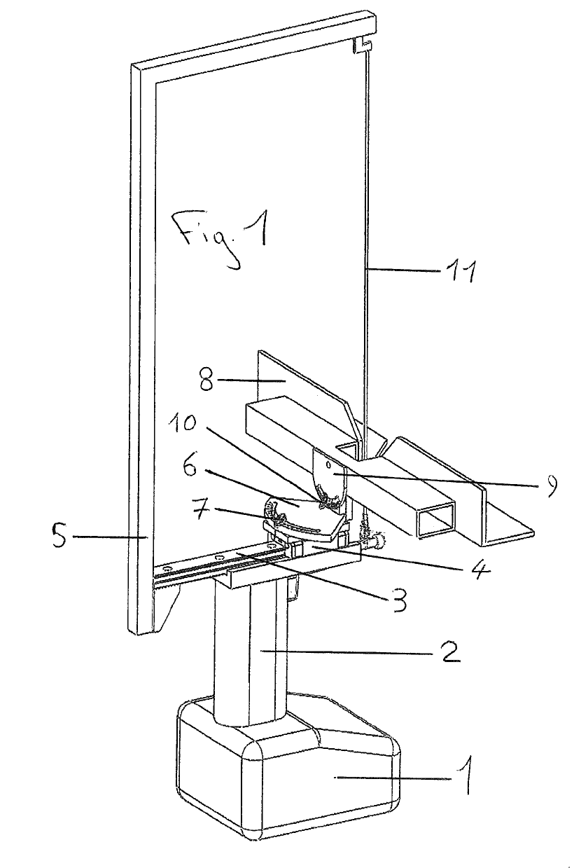

FIG. 2 is a diagrammatic view of the system of the appliance for providing guidance in translation, as seen looking in a second direction; and

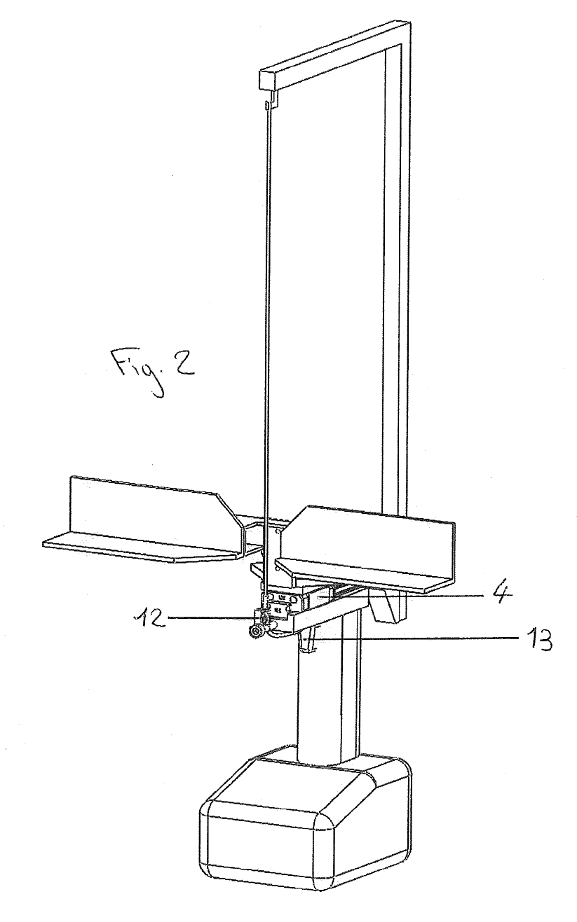

FIG. 3 shows the positioning of the appliance on material for cutting.

### DESCRIPTION OF A PREFERRED EMBODIMENT OF THE INVENTION

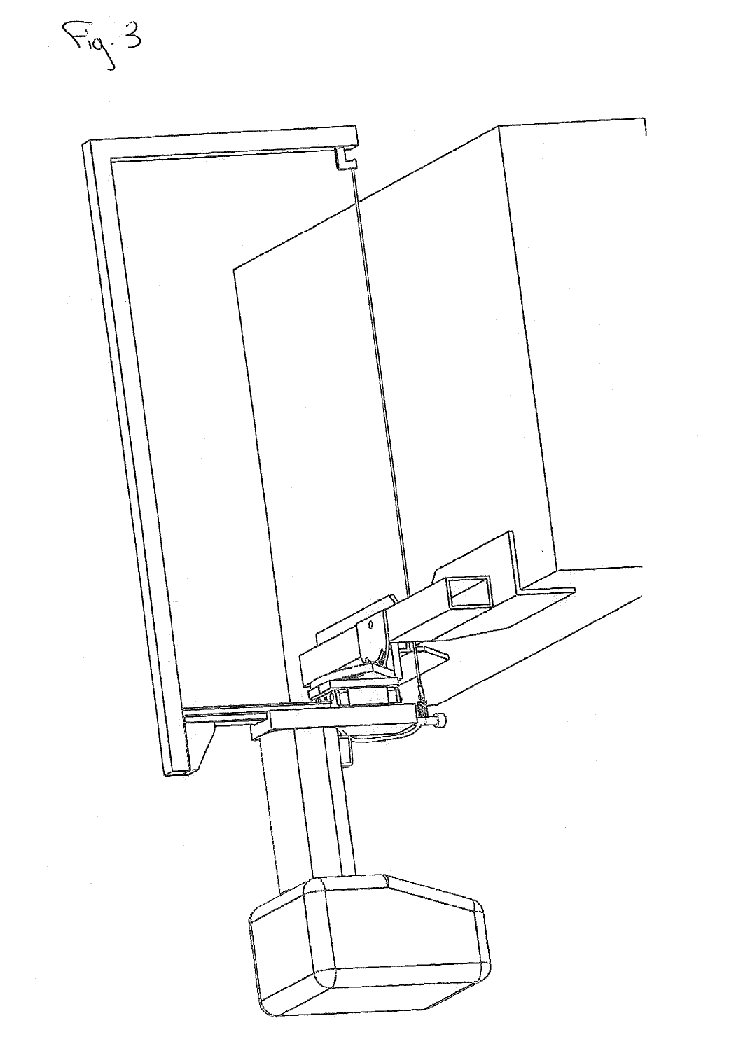

As shown in the various figures, the cutter appliance comprises a plastics grip body for gripping in the hand, which body is connected at one end to a rechargeable 18 V lithium-ion battery, with its other end being fastened vertically to a linear guide. An angle bar that can be swiveled in two dimensions is fastened to the movable guide portion so as to be able to make angled cuts, the angle bar serving to wedge and stabilize the appliance against the panel for cutting so as to obtain an accurately straight cut, as shown in FIG. 3.

An aluminum bracket is fastened to the top end of the metal rail. Material is cut using a wire that is tensioned between the end of the bracket and the body of the appliance, with the wire heating and melting the material when a button is pressed on the plastics body. A traction spring between the wire and the body of the appliance serves to tension the wire and compensate for its expansion.

The appliance includes a rechargeable battery 1 suitable for connection to the plastics grip body 2. The body 2 has fastened thereon a system for guiding linear movement in translation, the system comprising a metal guide rail 3 of length that may lie in the range 20 centimeters (cm) to 40 cm depending on the desired depth of cut, and a ball bearing 4.

An aluminum bracket 5 of size that may lie in the range 40 cm to 130 cm depending on the desired length and depth of cut is fastened to the top end of the rail 3. The slideway 4 carries a graduated aluminum protractor 6 that can swivel in the range 0° to 45° in the vertical plane and that can be locked with a wing nut 7. The protractor 6 has an aluminum angle bar 8 fastened thereto that can be swiveled from 0° to 45° in the horizontal plane, with a notch in its center so as to avoid touching the wire when swiveling the bar 8.

A graduated protractor 9 is fastened to the bar 8. It serves to set its angle and to block the angle with the wing nut 10. Between the end of the bracket 5 and the body 2 there is a resistor wire 11 that is tensioned by means of a traction spring 12. A pushbutton 13 allows electricity to flow in the wire 11, thereby heating it instantaneously. Once the appliance is in position on the material for cutting, it suffices to press on the button 13 and allow the appliance to move down without any effort.

The appliance is particularly intended for use with thermal insulation for housing.

Advantageously, the appliance presents a total weight of less than 2500 grams (g), a rechargeable battery in order to be hand portable. The cutting guide system is accurate, and the volume it occupies is negligible. The speed of cutting is very fast.

1. A hand portable electrical portable appliance for cutting polystyrene, the appliance being characterized in that it comprises:
a grip body;
a cutter wire tensioned between a bracket and the grip body;
a rechargeable battery for powering and heating the cutter wire under the control of a pushbutton;
a guiding angle bar configured to swivel in a vertical plane and in a horizontal plane; and
a linear rail screwed onto the grip body and co-operating with a ball bearing in order to enable the guide angle bar to slide so as to cut accurately straight.

2. An appliance according to claim 1, characterized in that the graduated protractor monitors the pivot angle of the guide angle bar on the vertical plane from 0° to 45° and locks it by means of a button.

3. An appliance according to claim 1, characterized in that the graduated protractor (9) monitors the pivot angle of the guide angle bar on the horizontal plane from 0° to 45° and locks it using the wing nut.
